(19) United States
(12) Patent Application Publication
(10) Pub. No.: US 2009/0094615 A1
(43) Pub. Date: Apr. 9, 2009

(54) Access Control Method, System and Device Using Access Control Method

(76) Inventors: Takeshi Ohno, Musashino-shi (JP); Akira Noguchi, Musashino-shi (JP)

Correspondence Address: EDWARDS ANGELL PALMER & DODGE LLP, P.O. BOX 55874, BOSTON, MA, 02205, US

(21) Appl. No.: 12/226,806

(22) PCT Filed: Mar. 22, 2007
(86) PCT No.: PCT/JP2007/055828

§ 371 Date: Oct. 27, 2008

(30) Foreign Application Priority Data
Apr. 26, 2006 (JP) 2006-121386

(51) Int. Cl. G06F 13/10; G06F 15/173

(52) U.S. Cl. 719/313; 709/226

(57) ABSTRACT

In an access control method for performing access control on resources of a device, the access control method includes: activating a program management function, an access management function and a resource management function on a running embedded OS (Operating System); segmenting plural applications operating on the device to allocate a segment identifier to each of the segmented applications, by the program management function; if access to the resources from an application is requested, deciding enabling and disabling of the access to the resources from the application by referring to an access enabling and disabling list based on the segment identifier, by the access management function; and if the access is enabled, notifying the application of a method of referring to the resources in which a request for acquisition is made, through the access management function and the program management function, by the resource management function.

### TECHNICAL FIELD

The present invention relates to an access control method of a function or resources of a device such as a computer, a system and device using the access control method, and more particularly, to an access control method capable of performing access control on plural applications in an embedded device having no display part such as a Cathode Ray Tube (CRT) or a Liquid Crystal Display (LCD) or having no input part such as a keyboard, a device using the access control method, and a system capable of performing consistent access between devices.

### BACKGROUND ART

The following references are known as a reference related to an access control method of a function or resources of a device such as a computer, a device using the access control method, or the like.

Patent Reference 1: Japanese Laid-open Patent Publication, JP-A-04-216158

Patent Reference 2: Japanese Laid-open Patent Publication, JP-A-07-141212

Patent Reference 3: Japanese Laid-open Patent Publication, JP-A-07-182287

Patent Reference 4: Japanese Laid-open Patent Publication, JP-A-11-238037

Patent Reference 5: Japanese Laid-open Patent Publication, JP-A-2001-306521

Patent Reference 6: Japanese Laid-open Patent Publication, JP-A-2004-054523

FIG. 9 is a configuration block diagram showing one example of a device using such an access control method. In FIG. 9, Reference numeral 1 is an input part such as a keyboard. Reference numeral 2 is a computation control part such as a Central Processing Unit (CPU) for controlling the whole device by reading a program such as an application or a general-purpose Operating System (OS) and executing the program. Reference numeral 3 is a display part such as a CRT or an LCD. Reference numeral 4 is a storage part such as a hard disk, Read Only Memory (ROM) or Random Access Memory (RAM) for storing the program such as the application or the general-purpose OS.

An output of the input part 1 is connected to the computation control part 2, and a control output of the computation control part 2 is connected to the display part 3. Also, the storage part 4 is mutually connected to the computation control part 2. Further, the input part 1, the computation control part 2, the display part 3 and the storage part 4 are included in a general-purpose computer 50.

An operation of the example shown in FIG. 9 will herein be described with reference to FIG. 10. FIG. 10 is a flow diagram to describe an operation of access control of the computation control part 2.

The computation control part 2 controls the whole computer 50 by reading a program such as an application or a general-purpose OS stored in the storage part 4 and sequentially executing the program. Then, in “S001” in FIG. 10, the computation control part 2 controls the display part 3 to display an input screen necessary for authentication using a user authentication function of the general-purpose OS.

In “S002” in FIG. 10, the computation control part 2 decides whether or not an identifier such as a user name necessary for authentication is inputted from the input part 1, and when the identifier is not inputted, the operation returns to step “S001” in FIG. 10.

In the case of deciding that the identifier is inputted in “S002” in FIG. 10, the computation control part 2 decides whether or not a user with the inputted identifier can access a function or resources of a device in “S003” in FIG. 10.

In the case of deciding that the user with the inputted identifier cannot access the function or the resources of the device in “S003” in FIG. 10, the operation returns to step “S001” in FIG. 10.

On the other hand, in the case of deciding that the user with the inputted identifier can access the function or the resources of the device in “S003” in FIG. 10, the computation control part 2 permits the access to the function or the resources of the device in “S004” in FIG. 10.

As a result of this, access control of the function or the resources of the device can be performed by displaying the input screen necessary for authentication using the user authentication function of the general-purpose OS and deciding whether or not the user can access the function or the resources of the device based on the inputted identifier.

Also, access control can be performed by a user name (identifier) consistent between plural computers using the user authentication function of the general-purpose OS.

However, in an embedded device without having a display part such as a CRT or an LCD or an input part such as a keyboard, the embedded device is operated in limited computing resources. Thus, there is a device in which access control of a function or the resources of the device is not performed.

FIG. 11 is a configuration block diagram showing one example of such an embedded device without having a display part such as a CRT or an LCD or an input part such as a keyboard.

In FIG. 11, reference numeral 5 is a computation control part such as a CPU for controlling the whole device by reading a program such as an application or an embedded OS and executing the program. Reference numeral 6 and reference numeral 7 are storage parts such as a hard disk, ROM or RAM in which the program such as the application or the embedded OS is stored. Also, the computation control part 5 and the storage parts 6 and 7 are included in an embedded device 51. Further, the computation control part 5 is mutually connected to the storage part 6 and the storage part 7.

An operation of the example shown in FIG. 11 will herein be described. The computation control part 5 controls the whole embedded device 51 by reading a program such as an application or an embedded OS stored in the storage part 6 or the storage part 7 and sequentially executing the program.

The embedded device 51 has a closed configuration, so that the need for access control of a function or resources of the device or user authentication is often eliminated.

### DISCLOSURE OF THE INVENTION

### Problems that the Invention is to Solve

However, even in an embedded device without having a display part such as a CRT or an LCD or an input part such as a keyboard, a function or resources of the embedded device may be accessed from plural applications operating in parallel and there is a need to perform access control on the function or the resources of the embedded device every operating applications.

In this case, by implementing a general-purpose OS and then using a user authentication function previously present in the general-purpose OS, access control every applications can be performed. However, there has been a problem in that it is difficult to implement the general-purpose OS which consumes many computing resources in the embedded device in which computing resources are limited.

Also, embedded OSes implemented in each of the embedded devices 51 are various and there has been a problem in that it is difficult to perform access consistent between the plural embedded devices in the case of using access control of the embedded OS.

Therefore, a problem that the present invention is to solve is to provide a device and an access control method capable of performing access control on plural applications in an embedded device, and a system capable of performing access consistent between plural embedded devices.

### Means for Solving the Problems

According to a first aspect of the present invention, in an access control method for performing access control on resources of a device, the access control method includes: activating a program management function, an access management function and a resource management function on a running embedded OS (Operating System); segmenting plural applications operating on the device to allocate a segment identifier to each of the segmented applications, by the program management function; if access to the resources from an application is requested, deciding enabling and disabling of the access to the resources from the application by referring to an access enabling and disabling list based on the segment identifier, by the access management function; and

if the access is enabled, notifying the application of a method of referring to the resources in which a request for acquisition is made, through the access management function and the program management function, by the resource management function.

According to the access control method described above, access control of plural applications can be performed.

In the access control method according to the first aspect of the present invention, the access control method further includes: objectifying and managing the resources, and also managing a manipulation with respect to the objectified resources, by the resource management function.

According to the access control method described above, access control of plural applications can be performed.

According to a second aspect of the present invention, in a device using a method of performing access control on resources of the device, the device includes: a storage part in which an embedded OS (Operating System) and an application are stored, and a computation control part which activates a program management function, an access management function and a resource management function on the embedded OS while running the embedded OS, and which causes the program management function to segment plural applications operating on the device and to allocate a segment identifier to each of the segmented applications, and which, when the access to the resources from the application is requested, causes the access management function to decide enabling and disabling of access to the resources from the application by referring to an access enabling and disabling list based on the segment identifier, and which, when the access is enabled, causes the resource management function to notify the application of a method of referring to the resources in which a request for acquisition is made, through the access management function and the program management function.

According to the above-described device, access control of plural applications can be performed.

In the device according to the second aspect of the present invention, the device further includes: a communication part for communicating with another terminal through a network.

According to the above-described device, access control of plural applications can be performed.

In the above-described device, the computation control part causes the program management function to add the segment identifier of a segment to which the application which requests the access is attached to the access request and send the segment identifier to the access management function in the case of deciding that the access request for pinpointing the accessed resources is received from the application under management of the program management function, and in the case of deciding that information is received from the access management function, the computation control part causes the program management function to notify the application which requests the access of the information.

According to the above-described device, access control of plural applications can be performed.

In the above-described device, the computation control part causes the access management function to extract the segment identifier added to the access request in the case of deciding that the request for access to the resources is received from the program management function, and in the case of deciding that the access to the resources is enabled by referring to the access enabling and disabling list based on the extracted segment identifier, the computation control part causes the access management function to acquire a method of referring to the resources from the resource management function and to notify the program control function of the method of referring to the resources, and in the case of deciding that the access to the resources is disabled by referring to the access enabling and disabling list based on the extracted segment identifier, the computation control part causes the access management function to record that the access is unauthorized and to notify the program control function that the access is disabled.

According to the above-described device, access control of plural applications can be performed.

In the above-described device, in the case of deciding that the request for acquisition of a method of referring to the resources is received from the access management function, the computation control part causes the resource management function to notify the access management function of the method of referring to the resources in which the request for acquisition is made.

According to the above-described device, access control of plural applications can be performed.

According to a third aspect of the present invention, a system includes: the plural devices; a management terminal for setting access control and segmentation management of the plural devices through the network; and plural user terminals for activating an application in segments respectively allocated to the plural devices.

According to the above-described system, consistent access can be performed between plural embedded devices. In the user terminal, an application can be activated in segments respectively allocated to the plural embedded devices. Also, a distributed application environment in which an application operates on plural embedded devices can be constructed.

In a fourth aspect of the present invention according to the system of the third aspect, the segment identifiers are grouped between the devices, and the access control is performed between the applications operating in the same group.

According to the above-described system, the access control can easily be performed between applications operating in different embedded devices.

In a fifth aspect of the present invention according to the system of the third aspect, the segment identifiers are grouped between the devices and the access control to resources of the devices is performed from the application operating in the same group.

According to the above-described system, access control of resources of each of the embedded devices can easily be performed from an application.

### EFFECT OF THE INVENTION

Effects of the present invention are as follows.

According to an access control method and a device of the present invention, a program management function, an access management function and a resource management function are activated on an embedded OS running on an embedded device, and the program management function segments plural applications operating on the embedded device and allocates a segment identifier to each of the segmented applications. In the case of requesting the access to resources from an application, the access management function decides enabling and disabling of the access to the resources from the application by referring to an access enabling and disabling list based on the segment identifier. If the access is enabled, the resource management function notifies the application of a method of referring to the resources in which a request for acquisition is made through the access management function and the program management function. Thus, access control of the plural applications can be performed.

Also, according to the third aspect of the present invention, a management terminal sets access control, segmentation management of plural embedded devices in which a program management function, an access management function and a resource management function operate on an embedded OS. Thus, consistent access can be performed between the plural embedded devices. In the user terminal, an application can be activated in segments respectively allocated to the plural embedded devices. Also, a distributed application environment in which the application operates on the plural embedded devices can be constructed.

Also, according to the fourth aspect of the present invention, segment identifiers are grouped between the embedded devices and access control can be performed between the applications operating in the same group. Thus, access control can easily be performed between the applications operating in different embedded devices.

Also, according to the fifth aspect of the present invention, segment identifiers are grouped between embedded devices and access control of resources of the embedded devices is performed from the application operating in the same group. Thus, access control of resources of each of the embedded devices can easily be performed from the application.

### BRIEF DESCRIPTION OF THE DRAWINGS

FIG. 1 is a configuration block diagram showing one embodiment of a device using an access control method according to the present invention;

FIG. 2 is an explanatory diagram to describe a function operating in an embedded device;

FIG. 3 is an explanatory diagram to describe details of a program management function;

FIG. 4 is a flow diagram to describe an operation of the program management function;

FIG. 5 is a flow diagram to describe an operation of an access management function;

FIG. 6 is a table showing one example of an access enabling and disabling list;

FIG. 7 is a flow diagram to describe an operation of a resource management function;

FIG. 8 is a configuration block diagram showing an embodiment when applied to a distributed application environment;

FIG. 9 is a configuration block diagram showing one example of a device using an access control method;

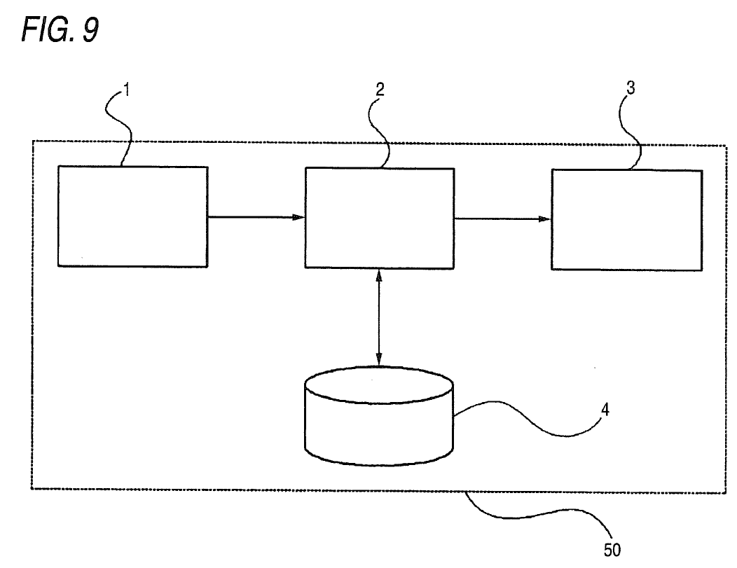

FIG. 10 is a flow diagram to describe an operation of access control of a computation control section; and

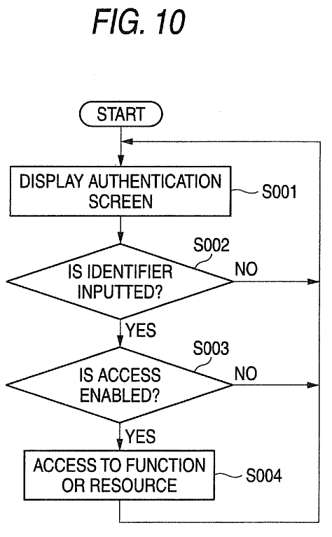

FIG. 11 is a configuration block diagram showing one example of an embedded device.

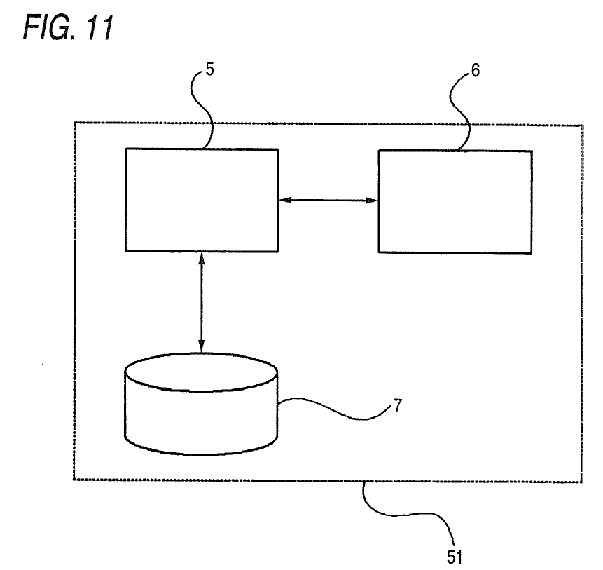

### DESCRIPTION OF REFERENCE NUMERALS AND SIGNS

1 INPUT PART
2,5,9 COMPUTATION CONTROL PART
3 DISPLAY PART
4,6,7,10,11 STORAGE PART
8 COMMUNICATION PART
12,13,14,51,52 EMBEDDED DEVICE
15 MANAGEMENT TERMINAL
16,17 USER TERMINAL
50 COMPUTER

### BEST MODE FOR CARRYING OUT THE INVENTION

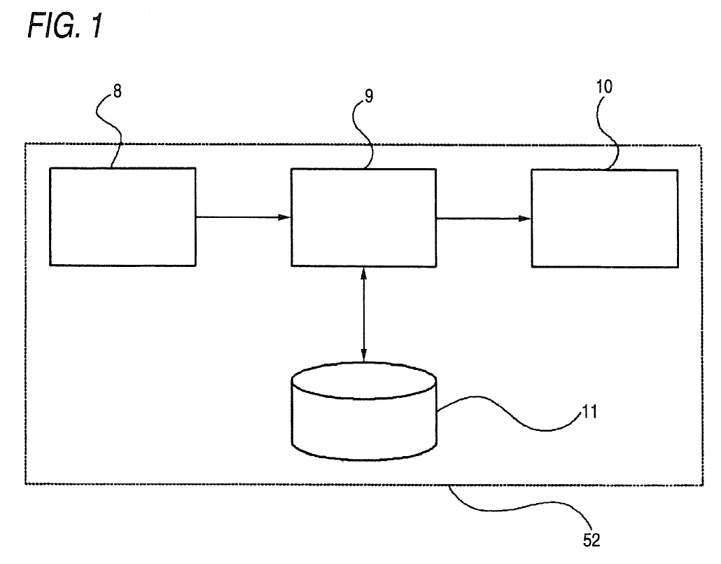

The present invention will hereinafter be described in detail with reference to the drawings. FIG. 1 is a configuration block diagram showing one embodiment of a device using an access control method according to the present invention.

In FIG. 1, reference numeral 8 is a communication part for communicating with other devices, apparatus, terminals, etc. through a network. Reference numeral 9 is a computation control part such as a CPU for controlling the whole device by reading a program such as an application or an embedded OS and executing the program. Reference numerals 10 and 11 are storage parts such as a hard disk, ROM or RAM in which the program such as the application or the embedded OS is stored. Also, the communication part 8, the computation control part 9 and the storage parts 10 and 11 are included in an embedded device 52.

An output of the communication part 8 mutually connected to the network (not shown) is connected to the computation control part 9, and the storage part 10 and the storage part 11 are mutually connected to the computation control part 9.

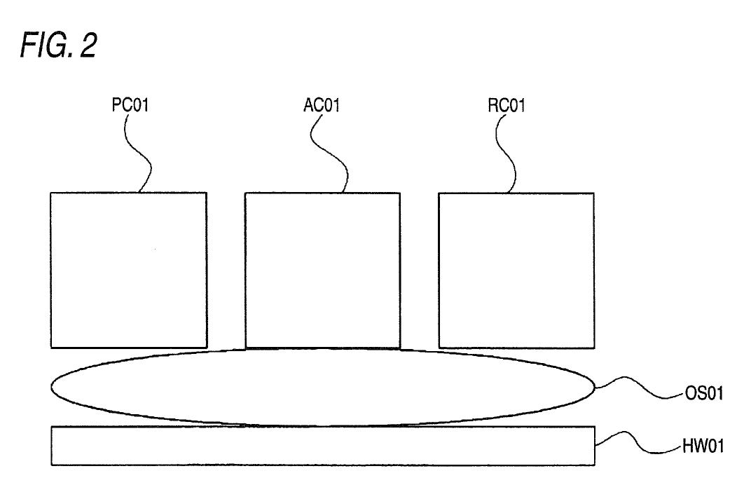

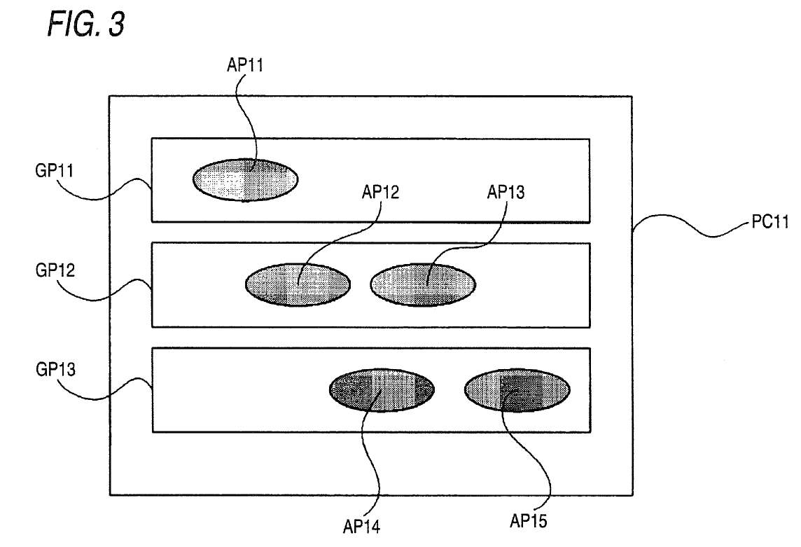

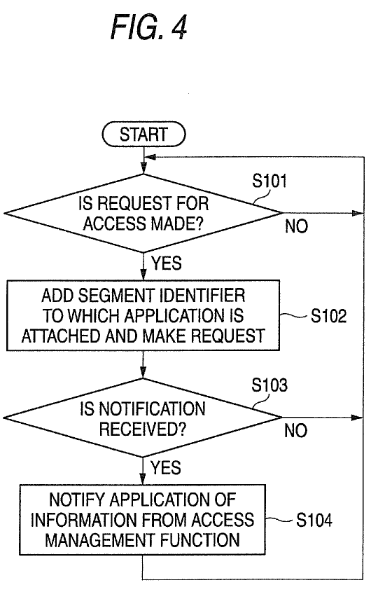

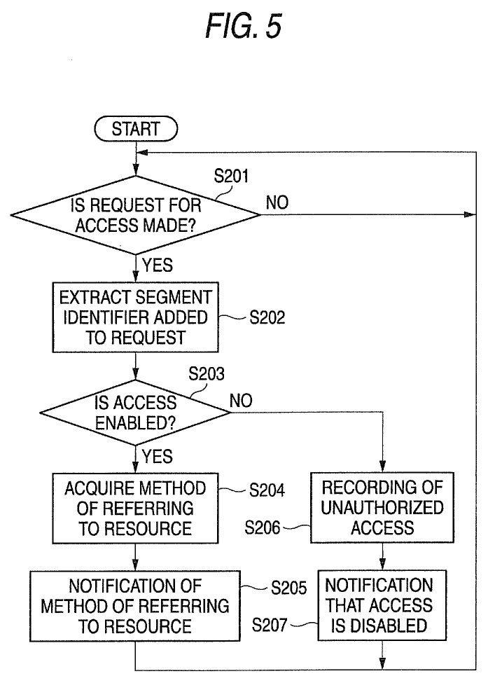

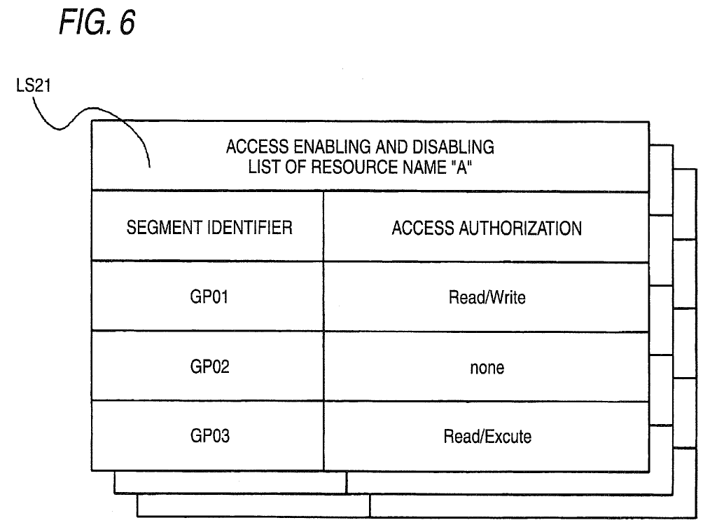

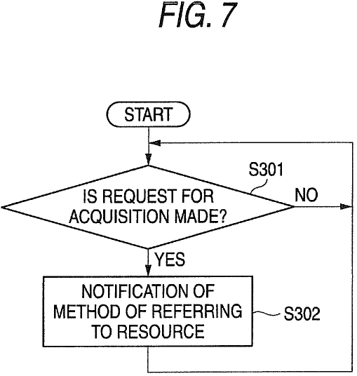

An operation of the embodiment shown in FIG. 1 will herein be described using FIGS. 2, 3, 4, 5, 6 and 7. FIG. 2 is an explanatory diagram to describe a function operating in the embedded device 52. FIG. 3 is an explanatory diagram to describe details of a program management function. FIG. 4 is a flow diagram to describe an operation of the program management function. FIG. 5 is a flow diagram to describe an operation of an access management function. FIG. 6 is a table showing one example of an access enabling and disabling list. FIG. 7 is a flow diagram to describe an operation of a resource management function.

An embedded OS shown in “OS01” in FIG. 2 runs on the embedded device 52 (concretely, the computation control part 9) shown in “HW01” in FIG. 2. Further, a program management function, an access management function and a resource management function shown in “PC01”, “AC01” and “RC01” in FIG. 2 respectively operate on the embedded OS shown in “OS01” in FIG. 2.

The program management function (concretely, the computation control part 9) shown in “PC01” in FIG. 2 segments plural applications operating on the computation control part 9, and allocates segment identifiers to the segmented plural applications.

For example, in the program management function (concretely, the computation control part 9) shown in “PC11” in FIG. 3, segments as shown in “GP11”, “GP12” and “GP13” in FIG. 3 are provided and an application shown in “AP11” in FIG. 3 is attached to the segment shown in “GP11” in FIG. 3 and thus the corresponding segment identifier is allocated.

Similarly, in the program management function (concretely, the computation control part 9) shown in “PC11” in FIG. 3, applications shown in “AP12” and “AP13” in FIG. 3 are respectively attached to the segments shown in “GP12” in FIG. 3 and “AP14” and “AP15” in FIG. 3 are respectively attached to the segments shown in “GP13” in FIG. 3 and the corresponding segment identifiers are respectively allocated.

On the other hand, the access management function shown in “AC01” in FIG. 2 has an access enabling and disabling list in which enabling and disabling of access are described every resources, and decides enabling and disabling of access by referring to the access enabling and disabling list in response to a request for access from an application to resources.

Finally, the resource management function shown in “RC01” in FIG. 2 objectifies and manages resources such as various functions, a device or I/O information of the embedded device 52 and also manages operations such as “readout”, “writing”, “execution” with respect to the objectified resources.

Also, the resource management function shown in “RC01” in FIG. 2 provides a method of referring to resources requested from an application.

For example, as the method of referring to resources, a method of accessing a storage part when the resource is the storage part itself, a method of accessing an address in which information is stored when the resource is the information stored in a storage part, or a method of accessing a pointer to a function when the resource is the function capability are contemplated.

Under such circumstances, the program management function (concretely, the computation control part 9) decides whether or not an access request for pinpointing resources (concretely, specifying a resource name) which want to be accessed is made from an application under management in “S101” in FIG. 4.

In the case of deciding that the access request is made in “S101” in FIG. 4, the program management function (concretely, the computation control part 9) adds a segment identifier of a segment to which the application in which the access request is made is attached to the access request and makes a request to the access management function in “S102” in FIG. 4.

In “S103” in FIG. 4, the program management function (concretely, the computation control part 9) decides whether or not information (a method of referring to resources, or notification that access is disabled) is received from the access management function. In case of deciding that the information is received, the program management function (concretely, the computation control part 9) notifies the application in which the access request is made of the received information in “S104” in FIG. 4.

Then, when the information received by the application is a method of referring to resources, the application accesses the resources requested based on the referring method.

On the other hand, in “S201” in FIG. 5, the access management function (concretely, the computation control part 9) decides whether or not a request for access to resources is made from the program management function. In the case of deciding that the request for access is made, the access management function (concretely, the computation control part 9) extracts a segment identifier added to the access request in “S202” in FIG. 5.

Then, the access management function (concretely, the computation control part 9) decides enabling and disabling of access to resources by referring to an access enabling and disabling list based on the extracted segment identifier in “S203” in FIG. 5.

Here, the access enabling and disabling list is a table as shown in “LS21” in FIG. 6 and, for example, it is apparent from the access enabling and disabling list of a resource name “A” that an application attached to a segment identifier “GP01” enables “reading” and “writing” with respect to the resource “A”.

Similarly, for example, it is respectively apparent from the access enabling and disabling list of the resource name “A” that an application attached to a segment identifier “GP02” disables access to the resource “A” and an application attached to a segment identifier “GP03” enables “reading” and “execution” with respect to the resource “A”.

In the case of deciding that the access to resources is enabled in “S203” in FIG. 5, the access management function (concretely, the computation control part 9) acquires a method of referring to resources from the resource management function in “S204” in FIG. 5 and the access management function (concretely, the computation control part 9) notifies the program control function of the method of referring to resources acquired in “S205” in FIG. 5.

Also, in the case of deciding that the access to resources is disabled in “S203” in FIG. 5, the access management function (concretely, the computation control part 9) makes recording to the effect that unauthorized access is made in “S206” in FIG. 5 and also the access management function (concretely, the computation control part 9) notifies the program control function that access is disabled in “S207” in FIG. 5.

Finally, the resource management function (concretely, the computation control part 9) decides whether or not a request for acquisition of a method of referring to resources is made from the access management function in “S301” in FIG. 7 and in the case of deciding that the request for acquisition of the method of referring to resources is made, the resource management function (concretely, the computation control part 9) notifies the access management function of the method of referring to resources in which the request for acquisition is made in “S302” in FIG. 7.

As a result of this, the program management function, the access management function and the resource management function are operated on the embedded OS running on the embedded device, and the program management function segments plural applications operating on the embedded device and allocates segment identifiers to the applications. In the case of making a request for access to resources from an application, the access management function decides enabling and disabling of access to the resources of the application by referring to an access enabling and disabling list based on the segment identifier. In the case of enabling the access, the resource management function notifies the application of a method of referring to the resources in which a request for acquisition is made through the access management function and the program management function. Thus, access control of the plural applications can be performed.

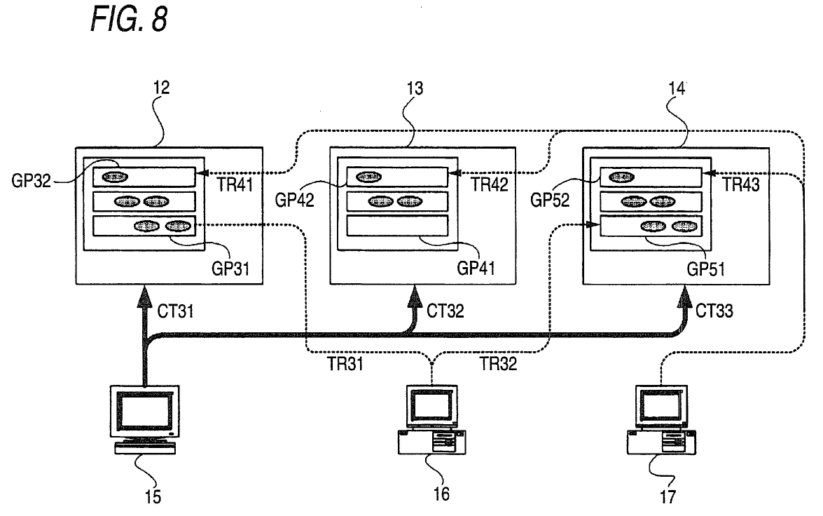

Also, FIG. 8 is a configuration block diagram showing an embodiment when applying such an access control method to a distributed application environment in which one application operates on plural distributed devices.

In FIG. 8, numerals 12, 13 and 14 are embedded devices in which a program management function, an access management function and a resource management function operate on the embedded OS as shown in FIG. 1. Numeral 15 is a management terminal for setting access control, segmentation management of each application, etc. Numerals 16 and 17 are user terminals for operating applications in segments allocated respectively.

Also, the embedded device 12, the embedded device 13, the embedded device 14, the management terminal 15, the user terminal 16 and the user terminal 17 are mutually connected by a network (not shown) through each communication part.

As shown in “CT31”, “CT32” and “CT33” in FIG. 8, the management terminal 15 controls each of the embedded devices 12, 13 and 14 to define a segment with respect to the program management function and to set a segment identifier and then notifies the user terminals 16 and 17 of the segment identifier.

Also, as shown in “CT31”, “CT32” and “CT33” in FIG. 8, the management terminal 15 controls the embedded devices 12, 13 and 14 and sets enabling and disabling of access to each resource in each access enabling and disabling list of the embedded devices 12, 13 and 14.

On the other hand, the user terminals 16 and 17 manipulate segments corresponding to segment identifiers respectively allocated to the embedded devices. Concretely, the user terminals 16 and 17 perform control in which, for example, applications are transferred to segments respectively allocated to each of the embedded devices 12, 13 and 14 and are executed.

However, in the case of performing such a control, the user terminals 16 and 17 add segment identifiers and make requests to each of the embedded devices 12, 13 and 14.

For example, it is assumed that a segment identifier shown in “GP31” in FIG. 8 of the embedded device 12 and a segment identifier shown in “GP51” in FIG. 8 of the embedded device 14 are respectively allocated to the user terminal 16 and a segment identifier shown in “GP32” in FIG. 8 of the embedded device 12, a segment identifier shown in “GP42” in FIG. 8 of the embedded device 13 and a segment identifier shown in “GP52” in FIG. 8 of the embedded device 14 are respectively allocated to the user terminal 17.

In this case, as shown in “TR31” and “TR32” in FIG. 8, the user terminal 16 can respectively transfer applications to segments corresponding to the segment identifier “GP31” of the embedded device 12 and the segment identifier “GP51” of the embedded device 14 and then can execute the applications.

Similarly, as shown in “TR41”, “TR42” and “TR43” in FIG. 8, the user terminal 17 can respectively transfer applications to segments corresponding to the segment identifier “GP32” of the embedded device 12, the segment identifier “GP42” of the embedded device 13 and the segment identifier “GP52” of the embedded device 14 and then can execute the applications.

As a result of this, the management terminal makes setting of access control or segmentation management of plural embedded devices in which the program management function, the access management function and the resource management function operate on the embedded OS. Thus, consistent access can be performed between the plural embedded devices. In the user terminal, an application can be operated in segments respectively allocated to the plural embedded devices.

Also, a distributed application environment in which an application operates on plural embedded devices can be constructed.

In addition, in the embodiment shown in FIG. 1, the communication part 8 is illustrated, but when the embedded device operates in only a single unit and is closed to the outside, the communication part 8 is not an essential component.

Also, the resource management function objectifies and manages resources of the embedded device 52 and also manages operations such as “readout”, “writing”, or “execution” with respect to the objectified resources. However, the resource management function may objectify and manage combinations of plural resources or may manage combinations of plural manipulations.

Also, in FIG. 8, segment identifiers may be grouped between each of the embedded devices and access control may be performed between applications operating in the same group. Naturally, mutual access between applications attached to other groups is not permitted.

Concretely, the segment identifiers shown in “GP31”, “GP41” and “GP51” in FIG. 8 and the segment identifiers shown in “GP32”, “GP42” and “GP52” in FIG. 8 are respectively grouped and mutual access (information exchange etc.) between applications operating in the same group is permitted and mutual access between applications attached to other groups is not permitted.

As a result of this, access control between applications operating in different embedded devices can easily be performed.

Similarly, segment identifiers may be grouped between each of the embedded devices and access control of resources of each of the embedded devices may be performed from an application operating in the same group.

Concretely, the segment identifiers shown in “GP31”, “GP41” and “GP51” in FIG. 8 and the segment identifiers shown in “GP32”, “GP42” and “GP52” in FIG. 8 are respectively grouped and permission or non-permission of access to resources of each of the embedded devices is controlled with respect to an application operating in the same group.

As a result of this, access control of resources of each of the embedded devices can easily be performed from an application.

The present application is based on Japanese patent application No. 2006-121386 filed on Apr. 26, 2006, and the contents of the patent application are hereby incorporated by reference.

1. An access control method for performing access control on resources of a: device, the access control method comprising:
activating a program management function, an access management function and a resource management function on a running embedded OS (Operating System);
segmenting plural applications operating on the device to allocate a segment identifier to each of the segmented applications, by the program management function;
if access to the resources from an application is requested,
deciding enabling and disabling of the access to the resources from the application by referring to an access enabling and disabling list based on the segment identifier, by the access management function; and
if the access is enabled,
notifying the application of a method of referring to the resources in which a request for acquisition is made, through the access management function and the program management function, by the resource management function.

2. The access control method of claim 1, further comprising:
objectifying and managing the resources, and also managing a manipulation with respect to the objectified resources, by the resource management function.

3. A device using a method of performing access control on resources of the device, the device comprising:
a storage part in which an embedded OS (Operating System) and an application are stored, and
a computation control part which activates a program management function, an access management function and a resource management function on the embedded OS while running the embedded OS, and which causes the program management function to segment plural applications operating on the device and to allocate a segment identifier to each of the segmented applications, and which, when the access to the resources from the application is requested, causes the access management function to decide enabling and disabling of access to the resources from the application by referring to an access enabling and disabling list based on the segment identifier, and which, when the access is enabled, causes the resource management function to notify the application of a method of referring to the resources in which a request for acquisition is made, through the access management function and the program management function.

4. The device of claim 3, further comprising:
a communication part for communicating with another terminal through a network.

5. The device of claim 4, wherein
the computation control part causes the program management function to add the segment identifier of a segment to which the application which requests the access is attached to the access request and send the segment identifier to the access management function in the case of deciding that the access request for pinpointing the accessed resources is received from the application under management of the program management function, and
in the case of deciding that information is received from the access management function, the computation control part causes the program management function to notify the application which requests the access of the information.

6. The device of claim 4, wherein
the computation control part causes the access management function to extract the segment identifier added to the access request in the case of deciding that the request for access to the resources is received from the program management function, and
in the case of deciding that the access to the resources is enabled by referring to the access enabling and disabling list based on the extracted segment identifier, the computation control part causes the access management function to acquire a method of referring to the resources from the resource management function and to notify the program management function of the method of referring to the resources, and
in the case of deciding that the access to the resources is disabled by referring to the access enabling and disabling list based on the extracted segment identifier, the computation control part causes the access management function to record that the access is unauthorized and to notify the program control function that the access is disabled.

7. The device as claimed in claim 4, wherein
in the case of deciding that the request for acquisition of a method of referring to the resources is received from the access management function, the computation control part causes the resource management function to notify the access management function of the method of referring to the resources in which the request for acquisition is made.

8. A system comprising:
the plural devices of claim 4;
a management terminal for setting access control and segmentation management of the plural devices through the network; and
plural user terminals for activating an application in segments respectively allocated to the plural devices.

9. The system of claim 8, wherein the segment identifiers are grouped between the devices, and the access control is performed between the applications operating in the same group.

10. The system of claim 8, wherein the segment identifiers are grouped between the devices and the access control to resources of the devices is performed from the application operating in the same group.
